(19) United States
(12) Patent Application Publication
(10) Pub. No.: US 2010/0129638 A1
(43) Pub. Date: May 27, 2010

(54) Assemblable Foam Material

(76) Inventors: Fang-Juei CHOU, Taipei City (TW); Chun-Yung YU, Taipei City (TW); Liang Jar JEAN, Taipei City (TW); Han- Hsing HSIUNG, Banqiao City (TW)

Correspondence Address: SINORICA, LLC, 2275 Research Blvd., Suite 500, ROCKVILLE, MD, 20850, US

(21) Appl. No.: 12/397,401

(22) Filed: Mar. 4, 2009

(30) Foreign Application Priority Data
Nov. 21, 2008 (TW) 097145206

(51) Int. Cl. B32B 3/26

(52) U.S. Cl. 428/316.6

(57) ABSTRACT

The present invention provides an assemblable foam material, which mainly uses a plurality of joint members for jointing a plurality of foam materials. The present invention uses a simple jointing technology to joint the plurality of foam materials and form an assemblable foam material with neat and beautiful joints.

### FIELD OF THE INVENTION

The present invention relates generally to an assemblable material, and particularly to an assemblable foam material.

### BACKGROUND OF THE INVENTION

The decoration works according to the prior art include the work using the foam material as the base material. For example, while laying a carpet, floorboards or woods, a foaming material will be laid firstly on the floor in order to take advantage of material characteristics, such as sound and heat insulation, of the foaming material. Because the size of a foaming material is limited, if a large-area floor is to be laid, a plurality of foam materials has to be jointed to form a large-area foam material. According to the prior art, roughly two works are adopted to form a large-area foam material. The first work pastes a twin adhesive along same edge of the foam materials. By jointing the twin adhesive with the bottom of the adjacent foam material, adjacent foam materials are jointed to form a large-area foam material. However, the jointing structure of the first work described above tends to produce surface roughness and seams at the joints, and thereby making sound and heat insulation unreliable.

The second work mainly pastes a thin joint layer on surfaces of each foam material. The length of the joint layer is approximately equal to that of the foam material. When the joint layer is pasted in the foam material, it is shifted relative to the position of the foam material. Namely, one edge of the joint layer falls back on the surface of the foam material, making the other edge of the joint layer protrude the far edge of the foam material. Next, paste a twin adhesive on the surface of the foam material without the joint layer. Thereby, when every two foam materials approach each other, the portion of the joint layer protruding one edge of a foam material touches the surface of the adjacent foam material with the twin adhesive and the two bond together to form a large-area foam material. Nevertheless, the complicated laying processes of said two works increase manufacturing and construction costs, hence unfavorable for promotion.

Accordingly, the present invention provides an assemblable foam material, which uses a simple jointing technology to joint a plurality of foam materials for forming a large-area foam material. Thus, the problem described above can be solved.

### SUMMARY

An objective of the present invention is to provide an assemblable foam material, which uses a simple jointing technology to joint a plurality of foam materials and form an assemblable foam material with neat and beautiful joints.

In order to achieve the objective described above, the present invention provides an assemblable foam material comprising a plurality of foam materials and a plurality of joint members. The plurality of foam materials uses the plurality of joint members to joint with each other and form an assemblable foam material.

### BRIEF DESCRIPTION OF THE DRAWINGS

FIG. 1 shows a structural schematic diagram according to a preferred embodiment of the present invention;

FIG. 2 shows a structural schematic diagram according to another preferred embodiment of the present invention;

FIG. 3 shows a structural schematic diagram according to another preferred embodiment of the present invention;

FIG. 4 shows a structural schematic diagram according to another preferred embodiment of the present invention; and

FIG. 5 shows a structural schematic diagram according to another preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

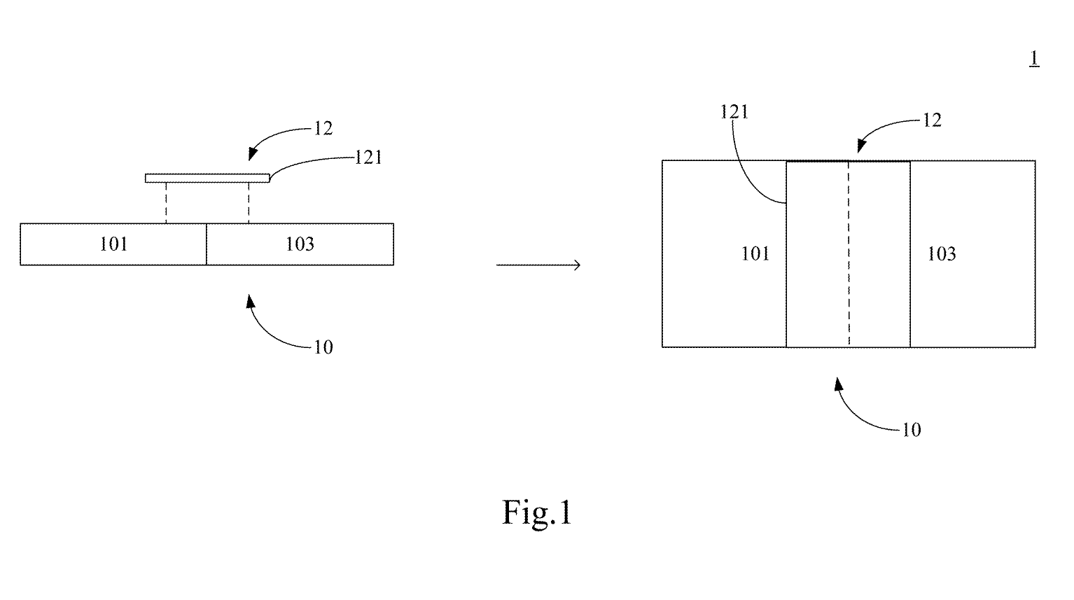

FIG. 1 shows a structural schematic diagram according to a preferred embodiment of the present invention. As shown in the figure, the present preferred embodiment provides an assemblable foam material 1 comprising a plurality of foam materials 10 and a plurality of joint members 12. The plurality of foam materials 10 uses the plurality of joint members 12 to joint with each other and form the assemblable foam material 1. The materials of the plurality of foam materials 10 include plastics, polypropylene, polyethylene, rubber, or composite materials. The plurality of foam materials 10 includes a first foam material 101 and a second foam material 103. The first foam material 101 is adjacent to the second foam material 103. The joint member 12 is an adhesive membrane 121, for example, a twin adhesive. The adhesive membrane 121 of the joint member 12 bonds the side of the first foam material 101 adjacent to the second foam material 103 to the side of the second foam material 103 adjacent to the first foam material 101.

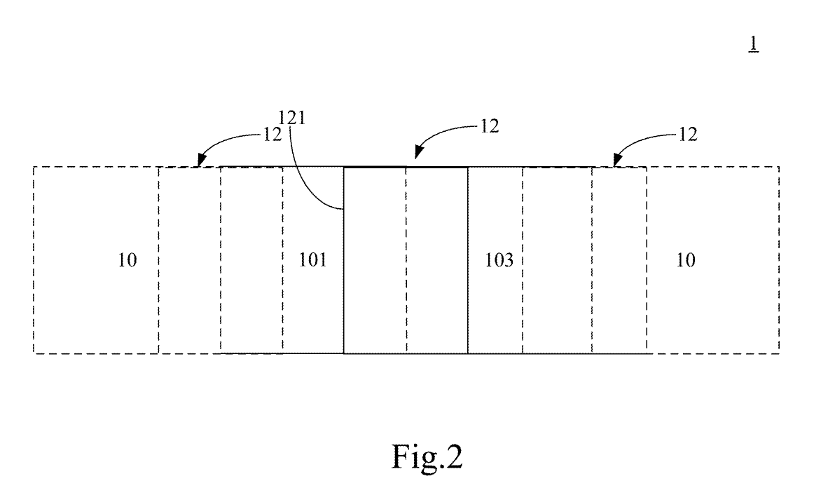

FIG. 2 shows a structural schematic diagram according to another preferred embodiment of the present invention. As shown in the figure, similar to the preferred embodiment describe above, the first foam material 101 or the second foam material 103 can further joint a plurality of foam materials 10. A plurality of joint members 12 is used between the foam materials 10 for bonding them in the same way shown in FIG. 1. As shown in FIG. 2, the first foam material 101 or the second foam material 103 joints the plurality of foam materials 10, which is arranged in a one-dimensional matrix to form the assemblable foam material 1.

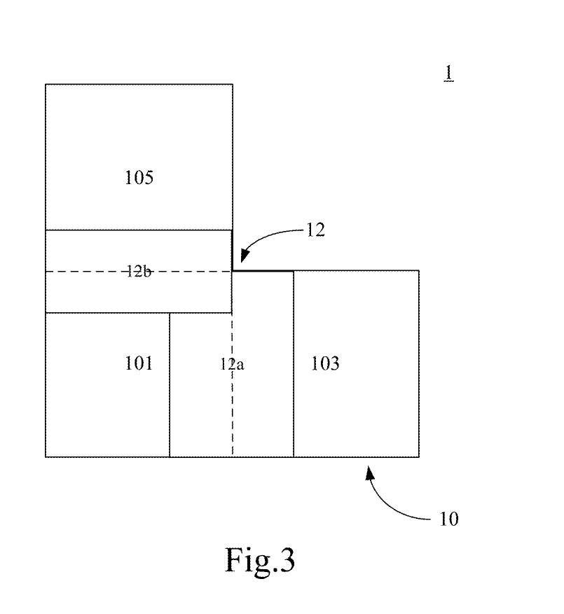

FIG. 3 shows a structural schematic diagram according to another preferred embodiment of the present invention. As shown in the figure, the present preferred embodiment provides an assemblable foam material 1 comprising a plurality of foam materials 10 and a plurality of joint members 12. The plurality of foam materials 10 uses the plurality of joint members 12 to joint with each other and form the assemblable foam material 1. The materials of the plurality of foam materials 10 include plastics, polypropylene, rubber, or composite materials. The plurality of foam materials 10 includes a first foam material 101, a second foam material 103, and a third foam material 105. The first foam material 101 is adjacent to the second foam material 103; the third foam material 105 is adjacent to the first foam material 101. The first, second, and third foam materials 101, 103, 105 are arranged L-shaped. The plurality of joint members 12 includes a first joint member 12a and a second joint member 12b. The first and second joint members 12a, 12b are adhesive membranes, for example, twin adhesives. The adhesive membrane of the first joint member 12a bonds the side of the first foam material 101 adjacent to the second foam material 103 to the side of the second foam material 103 adjacent to the first foam material 101. The adhesive membrane of the second joint member 12b bonds the side of the first foam material 101 adjacent to the third foam material 105 to the side of the third foam material 105 adjacent to the first foam material 101.

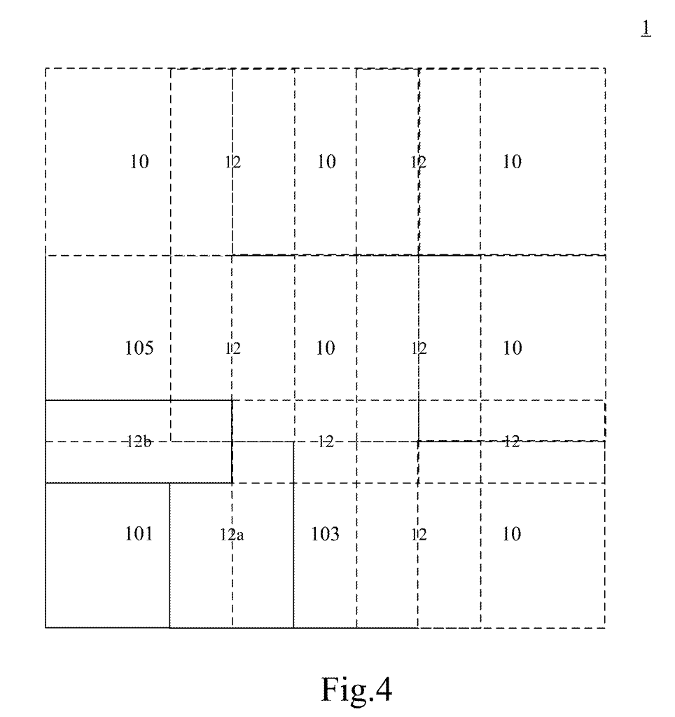

FIG. 4 shows a structural schematic diagram according to another preferred embodiment of the present invention. As shown in the figure, similar to the preferred embodiment describe above, the second foam material 103 and the third foam material 105 can further joint a plurality of foam materials 10. A plurality of joint members 12 is used between the foam materials 10 for bonding them in the same way shown in FIG. 3. As shown in FIG. 4, the second foam material 103 and the third foam material 105 joint the plurality of foam materials 10, which is arranged in a two-dimensional matrix to form the assemblable foam material 1.

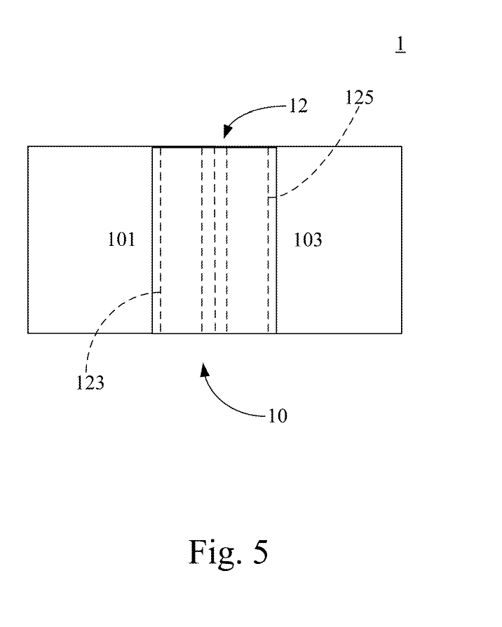

FIG. 5 shows a structural schematic diagram according to another preferred embodiment of the present invention. As shown in the figure, the present preferred embodiment provides an assemblable foam material 1 comprising a plurality of foam materials 10 and a plurality of joint members 12. The plurality of foam materials 10 uses the plurality of joint members 12 to joint with each other and form the assemblable foam material 1. The materials of the plurality of foam materials 10 include plastics, polypropylene, rubber, or composite materials. The plurality of foam materials 10 includes a first foam material 101 and a second foam material 103. The first foam material 101 is adjacent to the second foam material 103. The joint member 12 includes a first adhesive membrane 123 and a second adhesive membrane 125, for example, twin adhesives. The first adhesive membrane 123 of the joint member 12 bonds to the side of the first foam material 101 adjacent to the second foam material 103. The second adhesive membrane 125 of the joint member 12 bonds to the side of the second foam material 103 adjacent to the first foam material 101. The preferred embodiments described above can also use the jointing method described in the present preferred embodiment to joint the plurality of foam materials 10. The details will not be described again.

To sum up, the present invention provides an assemblable foam material, which mainly uses a plurality of joint members for jointing a plurality of foam materials. The present invention uses a simple jointing technology to joint the plurality of foam materials and form an assemblable foam material with neat and beautiful joints.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. An assemblable foam material, comprising:
a plurality of foam materials; and
a plurality of joint members, having an adhesive membrane, respectively, and bonding two foam materials of the plurality of foam materials to form the assemblable foam material.

2. The assemblable foam material of claim 1, wherein the material of the plurality of foam materials is plastics.

3. The assemblable foam material of claim 1, wherein the material of the plurality of foam materials is polypropylene.

4. The assemblable foam material of claim 1, wherein the material of the plurality of foam materials is rubber.

5. The assemblable foam material of claim 1, wherein the material of the plurality of foam materials is a composite material.

6. An assemblable foam material, comprising:
a plurality of foam materials; and
a plurality of joint members, having a first adhesive membrane and a second adhesive membrane, the first adhesive membrane bonding a foam material of the plurality of foam materials, the second adhesive membrane bonding another foam material of the plurality of foam materials, and the foam material bonded to the first adhesive membrane being adjacent to the foam material bonded to the second adhesive membrane.

7. The assemblable foam material of claim 6, wherein the material of the plurality of foam materials is plastics.

8. The assemblable foam material of claim 6, wherein the material of the plurality of foam materials is polypropylene or polyethylene.

9. The assemblable foam material of claim 6, wherein the material of the plurality of foam materials is rubber.

10. The assemblable foam material of claim 6, wherein the material of the plurality of foam materials is a composite material.
